(19) United States
(12) Patent Application Publication
(10) Pub. No.: US 2006/0026077 A1
(43) Pub. Date: Feb. 2, 2006

(54) Method and apparatus for bartering items

(76) Inventors: Mitchell S. Silverman, New York, NY (US); Boaz Salik, New York, NY (US); Omer Salik, Los Angeles, CA (US)

Correspondence Address: Omer Salik;Suite 4600, 555 W. Fifth Street, Los Angeles, CA, 90013-1025, US

(21) Appl. No.: 10/910,266

(22) Filed: Aug. 2, 2004

(51) Int. Cl. G06Q 30/00

(52) U.S. Cl. 705/26

(57) ABSTRACT

According to a computer-implemented approach for bartering items between customers, customers engage in the exchange of items wherein the system determines the parameters of the exchange. According to the approach, customers provide item selection criteria to a provider indicating items the customers desire to receive and items the customers are willing to send. In response to the item delivery criteria being satisfied, the provider prompts a customer to send an item to another customer, and the customer prompted by the provider sends the item to the other customer over a delivery channel. Provider determines the point value of the item sent and gives points to the customer sending the item and charges points from the customer receiving the item.

### BACKGROUND OF THE INVENTION

1. Field of Invention

The present invention relates to inventory bartering, and more specifically, to an approach for the exchange of items between a plurality of customers wherein the system determines the parameters of the exchange.

2. Background of Invention

Conventional models typically allow users to sell items either at a predetermined price, at a price set by auction or at a price negotiated between the parties. These types of models suffer from several significant limitations. First, a customer owning a relatively low-value item has very little incentive to sell that item, because the actual or perceived transaction and opportunity costs associated with selling the item may exceed the price obtained for the item. An example that illustrates this limitation is a customer owning a book that he or she has already read. The book may have a relatively low resale value, yet to realize an additional value from the book, the customer must either travel to a used bookstore or present the item for sale on an internet site. Often times, the customer perceives that the time and effort associated with selling his or her used book outweighs the amount of money the customer could obtain for that book. Further, the customer may also perceive that the value of the book to him or her exceeds the amount of money the customer could obtain for that book.

In response to the limitations of the conventional models, an alternative to the resale model of used and new items has appeared, whereby customers can trade items in exchange for cash or points. One example of such a model is found at www.swappingtons.com. Under this model, customers are required to offer one another “swap points” in exchange for books, and the customers thereby negotiate for available items using these “swap points.” This model presents significant shortcomings. First, this model forces customers to engage in an active offer and acceptance of “swap point” values and therefore fails to eliminate one of the significant transaction costs associated with selling an item, which may discourage trading. Further, this model provides no centralized system for determining the value and quality of a traded item, thereby creating uncertainty and inconsistency within the model, which may discourage trading.

Another example of a bartering model is found at www.sf-books.com. This model also has the shortcoming that customers must actively request trades from one another and therefore does not remove a significant transaction cost associated with selling an item. Further, this model credits customers providing an item and charges customers receiving an item with one point, regardless of the book sent and received. Thus, this model does not take into consideration the varying values of books and therefore discourages customers from bartering more valuable books.

Given the current demand to resell used items and the limitations in the prior approaches, an approach for facilitating the trading of items between customers that does not suffer from limitations of conventional models is desirable. In particular, an approach for trading items between customers that minimizes the transaction cost typically associated with reselling used items is desirable.

There is further a need for an approach for bartering items between customers that provides a centralized valuation system that will reward and thereby promote the trading of items.

There is yet a further need for an approach for batering books, movies, music and games between customers that is more convenient and flexible to customers than conventional approaches.

### SUMMARY OF THE INVENTION

According to one aspect of the invention, a method is provided for bartering items between customers. According to the method, one or more item selection criteria are received that indicate zero or more items that a customer desires to receive, and one or more item selection criteria are received that indicate zero or more items that a customer is willing to send. In response to the item delivery criteria being satisfied (such as, for example, an item selection criteria indicating an item that a customer desires to receive matching an item selection criteria indicating an item that another customer is willing to send) a customer is prompted to send an item. The customer sending an item is allotted a certain number points, and the customer receiving the item for trade is charged a certain number of points. The provider determines the point values. According to another aspect of the invention, the provider determines the point values and the point values are commensurate with the market value of the item sent and received. According to another aspect of the invention, the provider determines the point values and the point values are adjusted to promote the bartering of items.

According to another aspect of the invention, a computer-implemented method is provided for bartering items between customers. According to the method, one or more item selection criteria are received that indicate zero or more items that a customer desires to receive, and one or more item selection criteria are received that indicate zero or more items that a customer is willing to send. In response to the item delivery criteria being satisfied (such as, for example, an item selection criteria indicating an item that a customer desires to receive matching an item selection criteria indicating an item that another customer is willing to send) a customer is prompted to send an item. The customer sending an item is allotted a certain number of points, and the customer receiving the item is charged a certain number of points. Provider determines the point values. According to another aspect of the invention, provider determines the point values and the point values are commensurate with the market value of the item sent and received. According to another aspect of the invention, the provider determines the point values and the point values are adjusted to promote the bartering of items.

According to another aspect of the invention, a method is provided for bartering books between customers. According to the method, one or more book selection criteria are received that indicate zero or more books that the customer desires to receive, and one or more book selection criteria are received that indicate zero or more books that the customer is willing to send. In response to the item delivery criteria being satisfied (such as a book a customer is willing to send matches a book that another customer desires to receive) a customer is prompted to send the book to the customer desiring to receive the book. The customer sending the book is allotted points and the customer receiving the book is charged points. The provider determines the point value. According to another aspect of the invention, the provider determines the point values and the point values are commensurate with the market value of the book sent and received. According to another aspect of the invention, the provider determines the point values and the point values are adjusted to promote the bartering of books.

According to another aspect of the invention, a computer-implemented method is provided for bartering books between customers. According to the method, one or more book selection criteria are received that indicate zero or more books that the customer desires to receive, and one or more book selection criteria are received that indicate zero or more books that the customer is willing to send. In response to the item delivery criteria being satisfied (such as a book a customer is willing to send matches a book that another customer desires to receive) a customer is prompted to send the book to the customer desiring to receive the book. The customer sending the book is allotted points and the customer receiving the book is charged points. The provider determines the point values. According to another aspect of the invention, the provider determines the point values and the point values are commensurate with the market value of the book sent and received. According to another aspect of the invention, the provider determines the point values and the point values are adjusted to promote the bartering of books.

According to another aspect of the invention, an apparatus for bartering items between customers is provided. The apparatus comprises one or more processors and a memory communicatively coupled to the one or more processors. The memory includes one or more sequences of one or more instructions which, when executed by one or more of the two processors, cause the one or more processors to perform several steps. First, one or more item selection criteria are received that indicate zero or more items that a customer desires to receive. Second, one or more selection criteria are received that indicate zero or more items that a customer is willing to trade. Next, in response to the item delivery criteria being satisfied, a customer is prompted to send an item to another customer. The customer sending one or more item is allotted points, and the customer receiving one or more items is charged points. The point values are determined by the provider.

According to another aspect of the invention, an apparatus for bartering items between customers is provided. The apparatus comprises an item selection mechanism configured to receive one or more item selection criteria that indicate zero or more items that a customer desires to receive. The item selection mechanism is also configured to receive one or more item selection criteria that indicate zero or more items that a customer is willing to trade. The apparatus also comprises an item trading mechanism, which is configured to prompt a customer to send one or more items indicated by one or more item selection criteria in response to the item delivery criteria being satisfied. The apparatus also comprises a point distribution mechanism, which is configured to allot points to the customer sending one or more items and to charge points from the customer receiving one or more items. The point distribution mechanism is also configured to determine the point values.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a diagram depicting an approach for bartering items between customers according to an embodiment.

FIG. 2 is a flow diagram depicting an approach for bartering items between customers according to an embodiment.

FIG. 3 is a flow diagram depicting an approach for bartering items between customers according to an embodiment.

FIG. 4 is a flow diagram depicting an approach for bartering items between customers according to an embodiment.

FIG. 5 is a diagram illustrating an approach for bartering items between customers over the Internet according to an embodiment.

FIG. 6 is a block diagram of a computer system upon which embodiments of the invention may be implemented.

### DETAILED DESCRIPTION OF THE INVENTION

1. Functional Overview

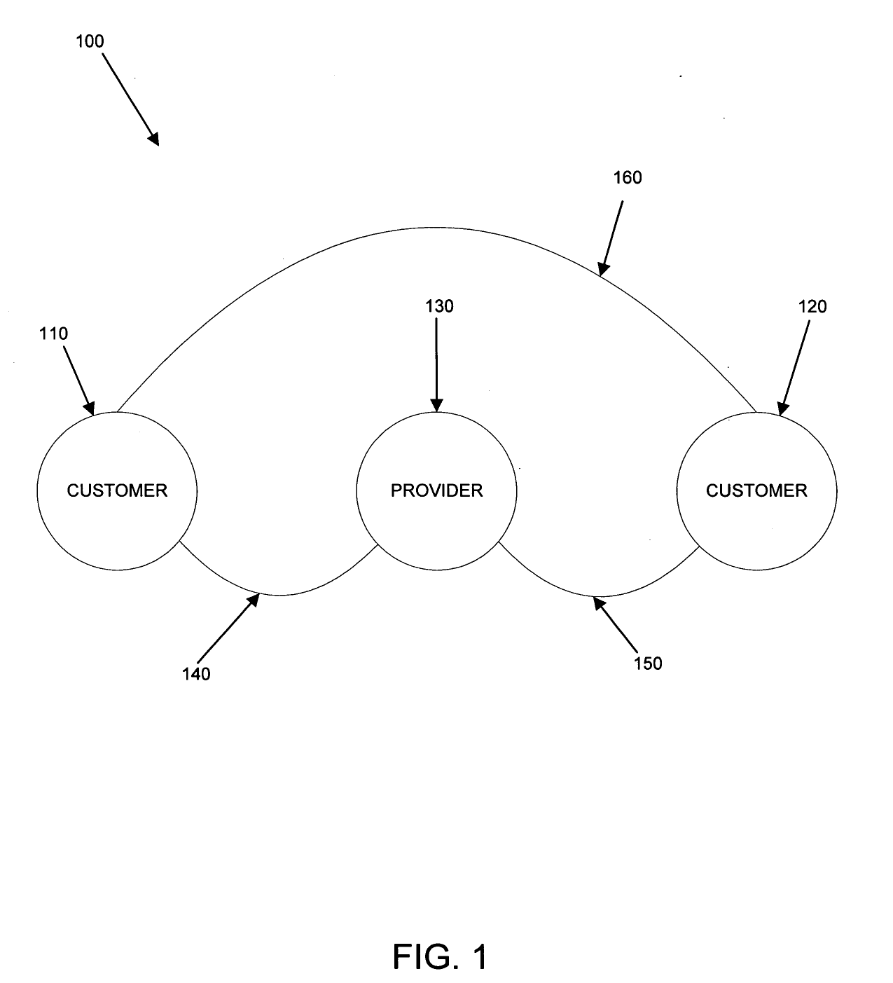

FIG. 1 is a block diagram 100 that illustrates an approach for bartering items between customers 110, 120 according to various embodiments described herein. As used herein, the term “item” and “items” refers to any commercial, real or personal goods, property or services that can be bartered or traded between customers 110, 120. Examples of items include books, movies, music, games, comic books, trading cards, data, software, analysis and the invention is not limited to any particular type of item. As used herein, the term “customer” and “customers” refers to any person or entity. The customers 110, 120 specify to provider 130 what item or items, if any, they desire to receive and what item or items, if any, they are willing to send to another customer. Although FIG. 1 illustrates only two customers 110, 120 and one provider 130, the number of customers and providers is not limited and other embodiments consistent with the invention described herein may include more than two customers or more than one provider.

According to one embodiment, a first customer 110 provides one or more item selection criteria to provider 130 over a link 140 and a second customer 120 provides one or more item selection criteria to provider 130 over a second link 150. Links 140, 150 may be any medium for transferring data between customer 110, 120 and provider 130 and the invention is not limited to any particular medium. Examples of a link 140, 160 include, without limitation, a network such as LAN, WAN or the Internet, a telecommunication link, a mail link, a wire or optical link, a telephone call, an in-person meeting, or a wireless connection.

The item selection criteria for the customers 110, 120 indicate items that each customer 110, 120 desires to receive from the other customer, if any, and items that each customer 110, 120 is willing to send to the other customer, if any. In one embodiment, a customer desiring to receive an item cannot view the items other customer or customers are willing to send. For example, in one embodiment customer 110 cannot view which item the second customer 120 is willing to send. In response to receiving the item selection criteria from customers 110, 120, provider 130 matches item selection criteria between customers 110, 120 to effectuate a trade, and after being prompted by provider 130 over a link 140, 150 second customer 120 sends first customer 110 the item over a delivery channel 160. In another embodiment, other than specifying to provider 130 which item or items they desire to receive and which item or items they are willing to send, the customers 110, 120 do not select which other customer will send them a particular item.

Delivery channel 160 may be implemented by any mechanism or medium that provides for the transfer of items from customer 130 to customer 120 and the invention is not limited to any particular type of delivery channel. Examples of delivery channel 160 include, without limitation, mail delivery, courier delivery, personal delivery, delivery using a delivery agent or electronic delivery.

According to an embodiment, provider 130 determines the value of the item sent from second customer 120 to first customer 110 using a point system, and provider 130 allots points to second customer 120 for sending an item and provider charges points from first customer 110 for receiving an item. In still another embodiment, the customer 110, 120 do not engage in a negotiation or offer-acceptance process regarding the value of the item sent. According to another embodiment, wherein there is more than one customer 110, 120 who may be selected to send an item, the provider 130 determines which customer 110, 120 to prompt to send the item. According to another embodiment, wherein there is more than one customer 110, 120 desiring to receive a particular item, the provider determines which of these customers 110, 120 will be selected to receive the item.

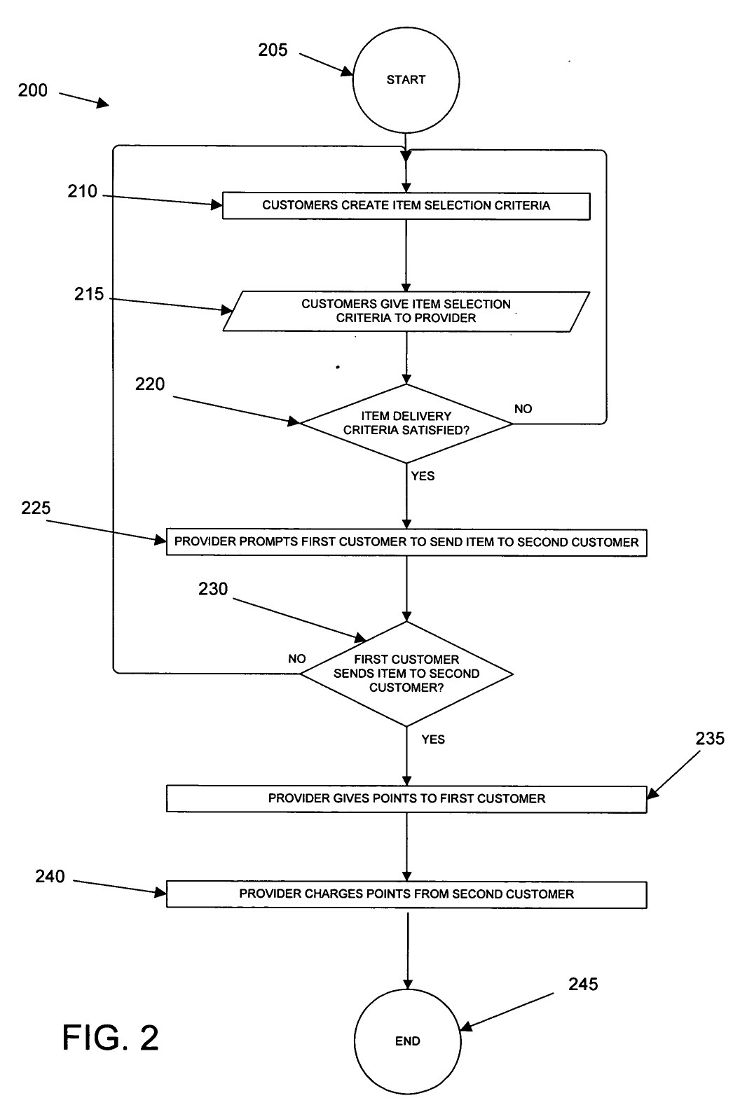

The approach just described for trading items between customers 110, 120 is now described with reference to a flow diagram 200 of FIG. 2. After starting in step 205, in step 210 customers create item selection criteria. In step 215, customers give item selection criteria to provider. Whether the item delivery criteria are satisfied is determined in step 220. If in step 220 the item delivery criteria are satisfied, in step 225 provider prompts customer to send an item or items to another customer. If, however, in step 220 the delivery criteria is not satisfied, the control returns to step 210.

If, after being prompted by provider in step 225 to send an item, customer sends the item in step 230 to a second customer, provider gives customer points in step 235 and charges the second customer points in step 240 and the process ends 245. If, however, customer does not send the item in step 230, the control returns to step 210. In one embodiment, the customer may be given a time period in which the customer must send the item in step 230. In other embodiments, the provider may maintain a record of customer's historical performance of sending items. This record may take into account whether the customer sends items when prompted to do so, the timeliness in which the customer sends items, the quality of the items sent by the customer, the quality of the delivery with which the customer sends the items and other factors that indicate a customer's performance within the system. In still other embodiments, this record may be made available to other customers or may be accessible only by the provider.

In other embodiments, the determinations made in steps 220 and 230 may return the control to other points in the flow diagram. For example, if in step 230 the first customer does not send the item to the second customer, the control may simply remain on step 230 until first customer does send the item to the second customer. In yet another embodiment, if in step 230 the first customer does not send the item to the second customer, the control may return to step 220 to determine whether another item delivery criteria may be satisfied. In still another embodiment, if the item delivery criteria 220 is not satisfied, the control may simply end 245.

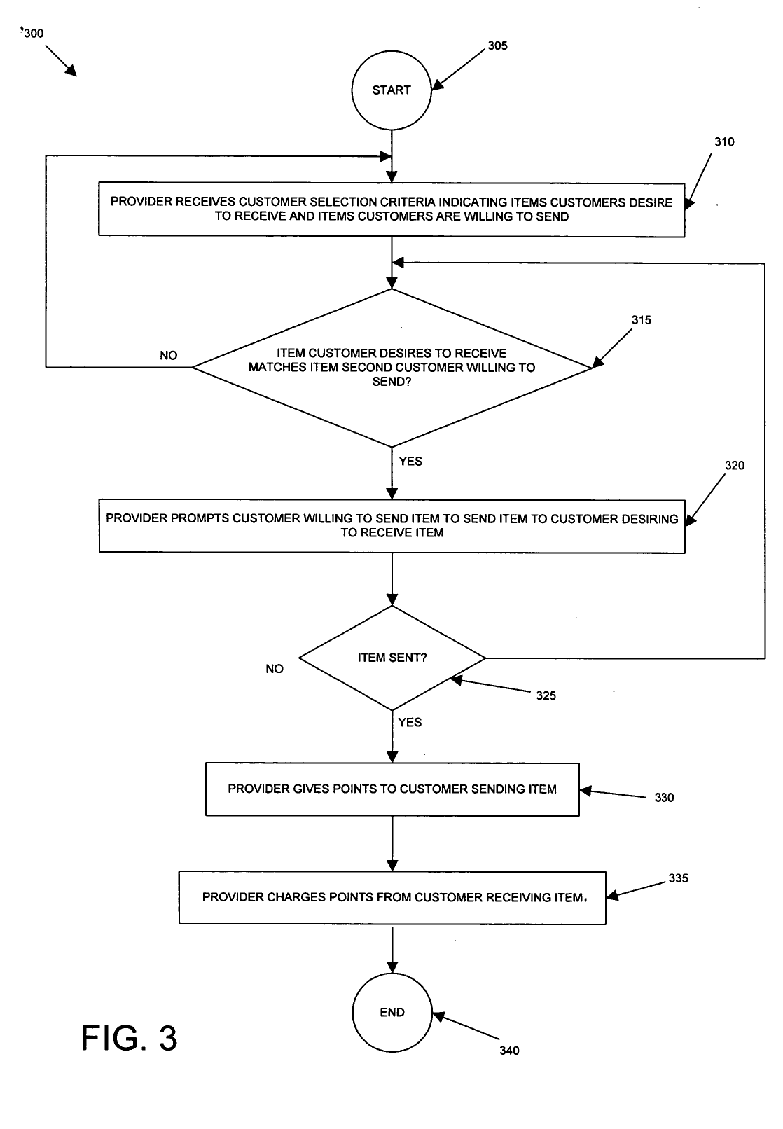

Another embodiment of the present invention is described in flow diagram 300 of FIG. 3. After starting 305, the provider receives customers' selection criteria indicating items customers desire to receive and items customers are willing to send 310, if any. In one embodiment, the receiving of these item selection criteria may occur in any sequence, including simultaneously, and at any time. In the next step 315, it is determined whether an item designated by a customer as an item that customer desires to receive matches an item a second customer designated as an item that second customer is willing to send. If the determination in step 315 is affirmative, in step 320, the provider prompts the customer willing to send the item to send the item to the customer desiring to receive the item. If the determination in step 315 is negative, the control returns to step 310.

In the determination of step 325, if customer sends the item which provider prompted customer to send in step 320, the provider gives the sending customer points in step 330. If, however, the customer does not send the item 325, then the control returns to step 315. It will be understood that in other embodiments, the control may be returned to other stages in the flow diagram 300. In certain embodiments, the customer may be given a time limit to send the item in step 325. In step 335 the provider charges points from the customer receiving the item sent by customer. Though for purposes of illustration steps 330 and 335 are shown separately and in sequence, it will be understood that in other embodiments, the provider 130 may give and charge points to customer in any sequence or simultaneously.

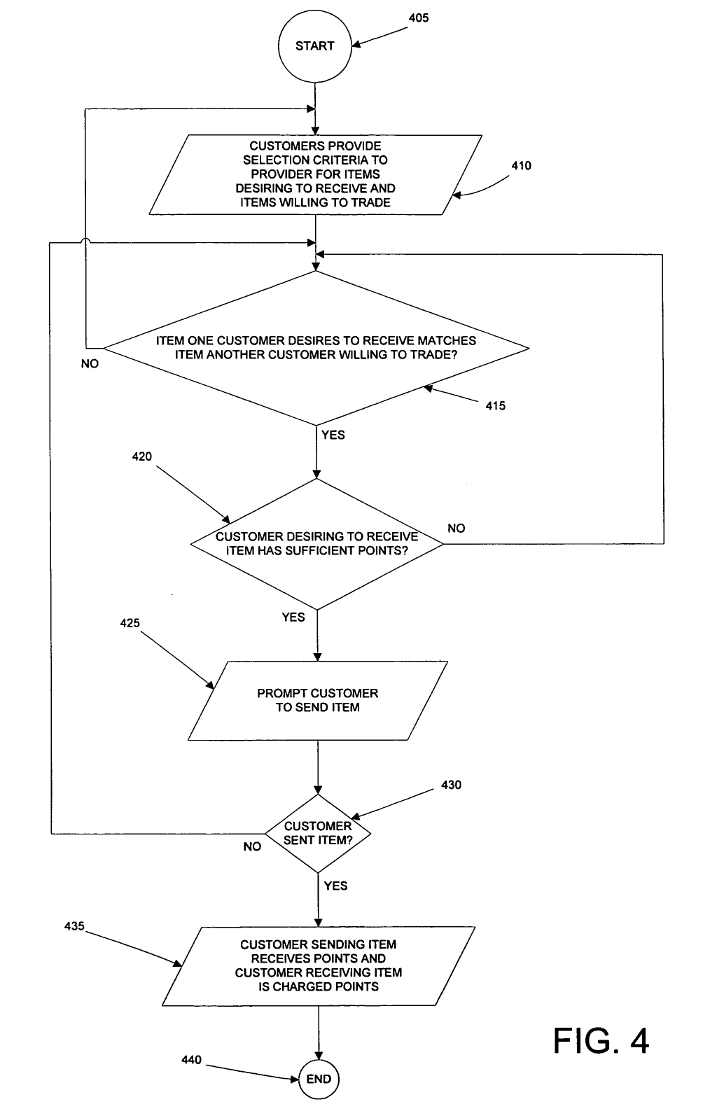

Another embodiment for the approach of bartering items described herein is described in the flow diagram 400 depicted in FIG. 4. After starting 405, customers provide item selection criteria to provider indicating items that customer desire to receive and are willing to send 410, if any. In step 415, it is determined whether an item that a first customer desires to receive matches an item that a second customer is willing to send. If this determination 415 is negative, the control is returned to step 410. If this determination 415 is affirmative, it is then determined whether the customer desiring to receive the item has sufficient points to receive the item 420. If this determination is negative, then the control is returned to step 415. In other embodiments, the customer may be offered to purchase more points in response to a negative determination in step 420. In still other embodiments, customers may be offered to purchase points at any time. If the determination in step 420 is affirmative, the provider prompts the customer willing to send the item to send the item to the customer desiring to receive the item. In step 430 it is determined whether the customer prompted to send the item sent the item to the customer desiring to receive the item. If the determination in step 430 is negative, then the control is returned to step 415, though in other embodiments the control may be returned to other points in the flow diagram 400. If the determination in step 430 is positive, the customer who sent the item receives points from provider and the customer receiving the item is charged points by provider. In certain embodiment, the customer prompted to send the item is given a time limit to send the item.

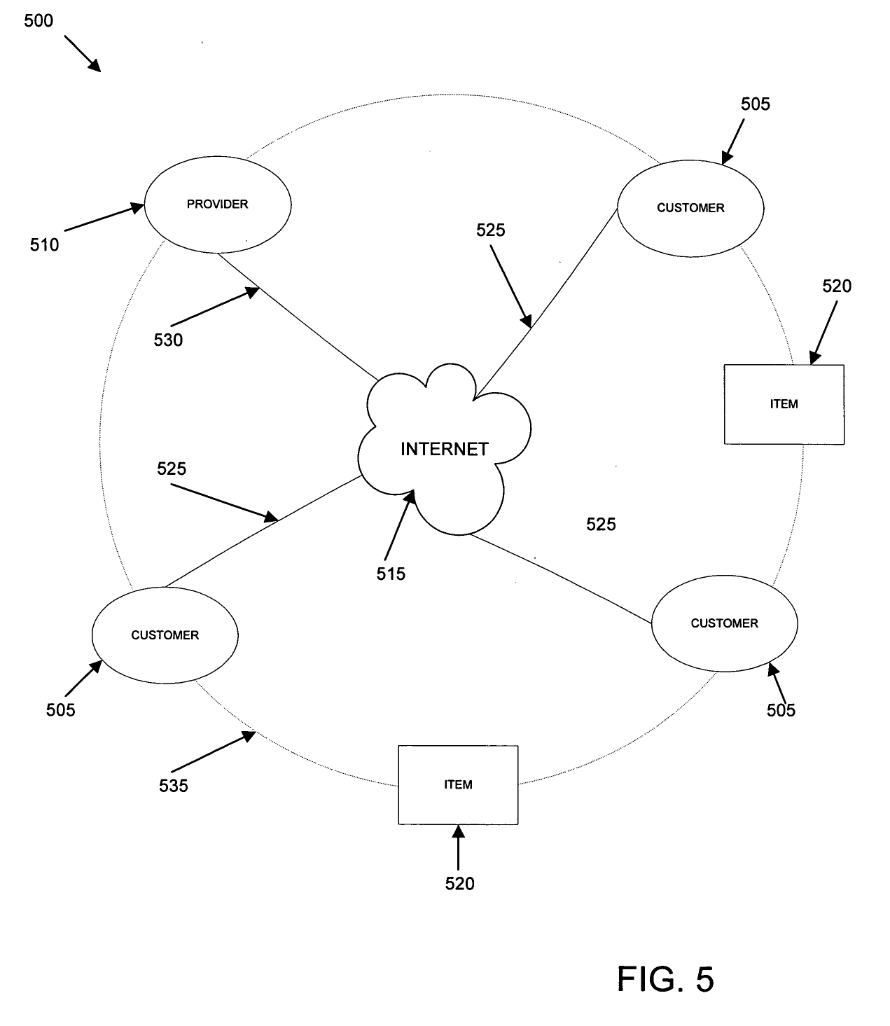

The approach for bartering items described herein is now described in the context of bartering items between customers. FIG. 5 is a diagram 500 that depicts a set of customers 505 that desire to barter items with other customers 505 and such bartering is facilitated by provider 510. Customers 505 communicate with provider 510 over links 525, the global packet-switched network referred to as the “Internet,” 515 and a link 530.

Links 525, 530 may be any medium for transferring data between customers 505 and the Internet 515 and provider 510, respectively, and the invention is not limited to any particular medium. In the present example, links 525, 530 may be connections provided by one or more Internet Service Providers (ISPs) and customers 505 are configured with generic Internet web browsers. Links 525, 530 may be secure or unsecured depending upon the requirements of a particular application.

In accordance with an embodiment, customers 505 enter into a bartering agreement with provider 510 to barter items 520 between customers 505 according to the approaches described herein. The invention is not limited to any particular approach for entering into the bartering agreement. For example, customers 505 and provider 510 may enter into a bartering agreement by mail, telephone, in person, or over the Internet 515, by customers 505 logging into a web site associated with provider 510. Customers 505 maintain a point account with provider 510.

Customers 505 create and provide item selection criteria to provider 510 over links 525, 530 and the Internet 515. The invention is not limited to any particular approach for specifying and providing item selection criteria to provider 510. For example, according to one embodiment, customers 505 provide item selection criteria to provider 510 in one or more data files. According to another embodiment, customer 505 log onto a web site associated with provider 510 and use a graphical user interface (GUI) to specify attributes of the items 520 that customers 505 desire to receive items 520 that customers 505 are willing to send, if any.

Once customers 505 and provider 510 have entered into a bartering agreement and customers 505 provide item selection criteria to provider 510, then provider 510 prompts customers 505 to send items 520 over delivery channels 535 to other customers 505 in accordance with the terms of the bartering agreement. For example, provider 510, in response to a matching of item delivery criteria, prompts a first customer to send an item to a second customer. If the first customer sends the item to the second customer, provider 510 gives the first customer points and the provider charges the second customer points. The giving and charging of points by provider 510 to and from customers 505 is reflected in the customers' 505 point accounts. In one embodiment, the customers 505 do not have direct contact with one another with the exception of the delivery channels 535.

2. Item Selection Criteria

The one or more item selection criteria provided by customers 505 to provider 510 indicates (1) the particular items that customer desires to receive, if any and (2) the particular items that customer is willing to send, if any. Thus, the item selection criteria define a customer-specific order set that may be fulfilled by another customer's or customers' 505 sending set, which is defined by another item selection criteria. According to one embodiment, the item selection criteria specify attributes of items to be received by one customer 505 from a second customer 505. Examples of item attributes include, without limitation, identifier attributes, type attributes and cost attributes. Identifier attributes refers to any attribute or attributes that may be used individually or in combination to identify a particular item. Examples of identifier attributes may include, but are not limited to, identifications of parameters such as title, author, artist, editor, producer, publisher, date of publication or release, edition, album, series, collection, brand name or ISBN number. Type attributes refers to any attribute or attributes that may be used individually or in combination to determine a type of an item. Examples of type attributes may include, but are not limited to, identifications of subject matter, genre, time period, language, product type or location. Cost attributes refers to any attribute or attributes that may be used individually or in combination to determine the cost or point value of an item. In one embodiment, item selection criteria may be changed at any time to reflect changes in items that customers 505 desires to receive and to send. In another, the item selection criteria indicating those items that customers 505 desire to receive may also be prioritized by customers to reflect those items customers 505 desire to receive more quickly, and, in another embodiment, the prioritization may be changed at any time.

3. Item Delivery Criteria

The item delivery criteria determines whether provider 510 will prompt a customer to send a particular item to a second customer. In one embodiment, the item delivery criteria searches for a match between a first customer's item selection criteria indicating an item the first customer desires to receive and a second customer's item selection criteria indicating an item the second customer is willing to trade or send. Such an embodiment is illustrated in step 315 of FIG. 3.

In the event that there are multiple such matches, the item delivery criteria determines which of the customers 505 will receive the item and which of the customers 505 will be prompted to send the item. For example, one possible occurrence is that a first customer's item selection criteria indicating an item which that customer desires to receive matches multiple other customers' item selection criteria indicating an item those customers are willing to send. In this situation, the item delivery criteria determines which of the customers indicating that they are willing to send the item will be prompted to send the item to the customer desiring to receive the item. In certain embodiments, more than one customer may be prompted to send the item. In other embodiments, only one customer is prompted to send the item.

In one embodiment, the item delivery criteria will randomly or arbitrarily determine which customer or customers to prompt. In another embodiment, the item delivery criteria will simply determine to prompt the customer whose item selection criteria indicating an item that customer is willing to send that first matches the item selection criteria indicating an item that the second customer desires to receive. In yet another embodiment, the item delivery criteria will balance multiple factors in determining which customer to prompt to send an item. Such factors may include a customer's historic reliability, a customer's reputation with respect to quality of items, the length of customer's participation, the number of points the customer has accumulated, and other factors. In one embodiment, these factors may be weighed to increase the likelihood of effecting a successful trade, though the factors can be weighed to adjust for other results.

As another example, one possible occurrence is that multiple customers' item selection criteria indicating an item which those customers desire to receive matches only one other customer's item selection criteria indicating an item that customer is willing to trade. In this situation, the provider will prompt the customer willing to send the item to send the item to one of the customers desiring to receive the item, and thereby selecting among those multiple customers desiring to receive the item. In one embodiment, the item delivery criteria will randomly or arbitrarily determine which customer to select among those desiring to receive the item. In another embodiment, the item delivery criteria will simply determine to select the customer whose item selection criteria indicating an item that customer is willing to send that first matches the item selection criteria indicating an item that the second customer desires to receive.

In yet another embodiment, the item delivery criteria will balance multiple factors in determining which customer to select among those customers desiring to receive an item. Such factors may include a customer's historic reliability, geographic proximity to the sending customer, a customer's reputation with respect to quality of items, the length of customer's participation, the number of points the customer has accumulated, and other factors. Because the provider may determine which customer will be prompted to send an item and which customer will receive the item, in one embodiment, the above factors may be weighed to increase the likelihood of effecting future trades, though the factors can be weighed to adjust for other results. The various parameters and factors described may be used or weighed individually or in any combination to comprise the item delivery criteria. The various parameters and factors described are illustrative and are not intended to limit the factors, parameters or considerations taken into account under the item delivery criteria.

4. Prompting of Customers

After the item delivery criteria is satisfied, the provider prompts a customer indicating a willingness to send the item to send the item to another customer indicating a desire to receive the item. In one embodiment, the prompting by provider can simply be a request to either or both customers to contact one another. In another embodiment, the provider identifies to the customer indicating a willingness to send the item to send the item and the provider identifies the address, or other routing protocol, of the customer indicating a desire to receive the item. In yet another embodiment, the provider may identify the item to send and give the customer indicating a willingness to send the item a shipping label with the address of the customer desiring to receive the item, or another routing protocol, or the necessary postage or shipping fees. This shipping label may have postage pre-paid or may require the customer sending the item to affix proper postage. A postage label may also be provided separately from a shipping label. The postage may be paid by the provider, may be paid by the customer sending the item or by the customer receiving the item. In one embodiment, the postage cost may be handled via an account with provider, and in still other embodiments, the postage cost may be paid for through various means, such as credit card, check, money order, electronic payment, cash or points. The timing of paying the postage may vary. For example, in one embodiment, the postage may be paid by the customer receiving the item upon delivery of the item. In other embodiments, a shipping and handling fee may be added to the cost of postage.

The shipping information may be sent to customers through various links, such as a network such as LAN, WAN or the Internet, a telecommunication link, a mail link, a wire or optical link, telephone, in-person, or a wireless connection. In one embodiment, a shipping label is sent via electronic mail or through an internet site, wherein the shipping label can be printed by the customer and used to ship the item. Examples of such electronic delivery of mailing labels can be found at various internet sites, such as www.usps.gov. The delivery of mailing labels can be provided directly by provider or can be provided by another vendor. In yet another embodiment, the provider may identify the item to send the customer indicating a willingness to send the item an envelope and/or other packaging material, which may include a shipping label attached. As described, the shipping label may contain the address of the customer desiring to receive the item, or another routing protocol. Also, the necessary postage and/or shipping fees may also be included. Any of the above prompting methods may be used individually or in a variety combinations with one another.

5. Point Determinations

A customer that sends an item that the provider prompted the customer to send receives points from provider, and the customer receiving the item is charged points by the provider. These point distributions may be maintained through a points account between the customer and provider. The provider determines the point value of bartered items. In one embodiment, the provider publishes the point value of particular items. In another embodiment, the point value may remain undisclosed. In either of these embodiments, the provider may either give and charge the same or different number of points to the customer sending as the customer receiving the item. For example, the provider may desire to reward a particular customer for sending an item additional points beyond the determined point value of the item sent. These rewards may be distributed, for example, to encourage future transactions or to reward past performance. In these situations, the customer sending the item may obtain more points than the number of points charged to the customer receiving the item.

The determination of the point values of particular items may be performed in various embodiments. In addition, the point value of items may be fixed or may vary. For example, in one embodiment, the point value given to the customer sending the item and the point value paid by the customer receiving the item can simply reflect the dollar value of that item if it were sold new. In another embodiment, the provider can determine the value of the item based on various factors, such as whether assigning a higher point value will promote trading and the historical participation of the customer receiving the item or the customer sending the item in trading. For example, in one embodiment, the provider may determine that numerous customers have identified the same item in their item selection criteria as an item they are willing to send and few customers have identified that same item in their item selection criteria as an item they wish to receive. In such a situation, the provider may lower the point value of that item to reflect the discrepancy between the supply of that item in the system and the demand for that item in the system. In other situations, the point value of a particular item may be raised. In another embodiment, the point value of a particular item may increase or decrease based on its weight so as to reflect the higher or lower shipping cost associated with sending that item. In yet another embodiment, the point value of a particular item may increase or decrease based on its popularity. In yet another embodiment, the point value of a particular item may differ for different users, and may be increased or decreased independently for each user. Several other factors may be used to determine whether the point value of a particular item should increase or decrease.

6. Implementation Mechanisms

The approach described herein for bartering items to customers is applicable to any type of bartering application and (without limitation) is particularly well suited for Internet-based bartering applications for conducting the exchange of books, movies and games between customers. The invention may be implemented in hardware circuitry, in computer software, or a combination of hardware circuitry and computer software and is not limited to a particular hardware or software implementation.

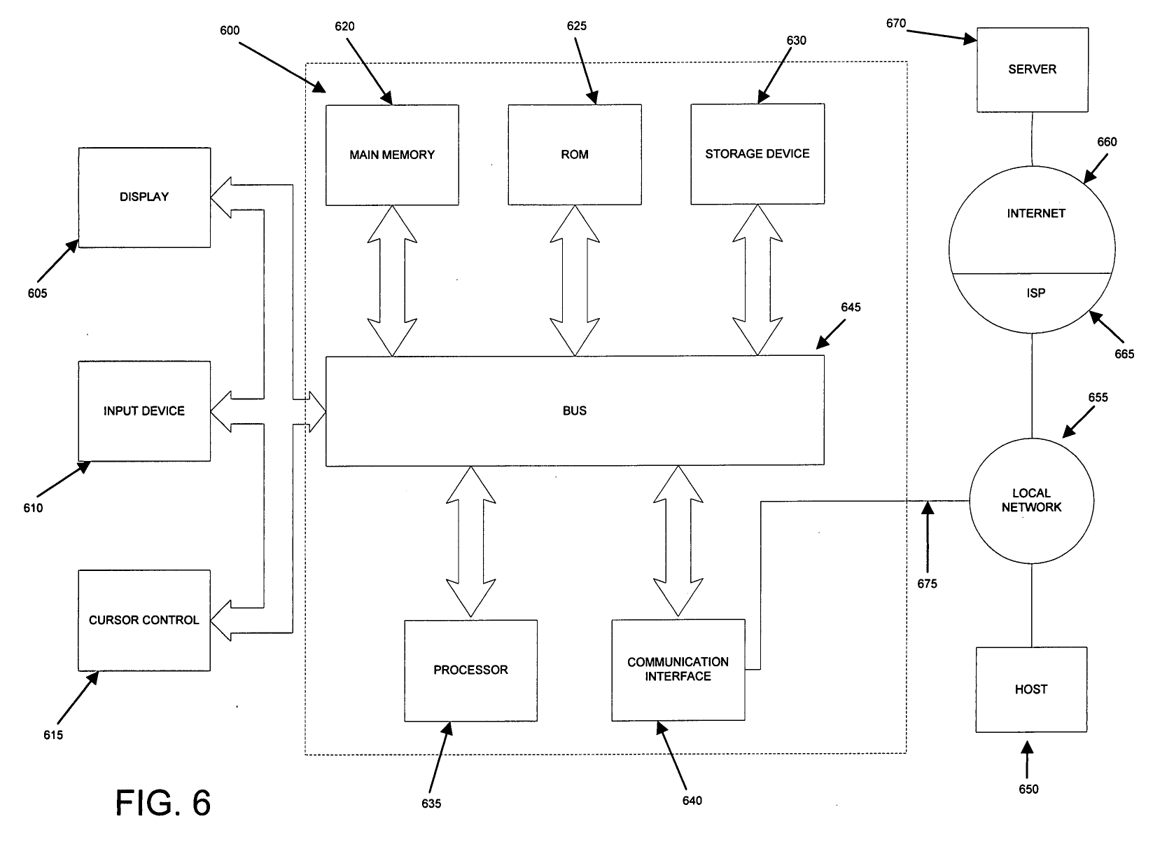

FIG. 6 is a block diagram that illustrates a computer system 600 upon which an embodiment of the invention may be implemented. Computer system 600 includes a bus 645 or other communication mechanism for communicating information, and a processor 635 coupled with bus 645 for processing information. Computer system 600 also includes a main memory 620, such as a random access memory (RAM) or other dynamic storage device, coupled to bus 645 for storing information and instructions to be executed by processor 635. Main memory 620 also may be used for storing temporary variables or other intermediate information during execution of instructions to be executed by processor 635. Computer system 600 further includes a read only memory (ROM) 625 or other static storage device coupled to bus 645 for storing static information and instructions for processor 635. A storage device 630, such as a magnetic disk or optical disk, is provided and coupled to bus 645 for storing information and instructions.

Computer system 600 may be coupled via bus 645 to a display 605, such as a cathode ray tube (CRT), for displaying information to a computer user. An input device 610, including alphanumeric and other keys, is coupled to bus 645 for communicating information and command selections to processor 635. Another type of user input device is cursor control 615, such as a mouse, a trackball, or cursor direction keys for communicating direction information and command selections to processor 635 and for controlling cursor movement on display 605. This input device typically has two degrees of freedom in two axes, a first axis (e.g., x) and a second axis (e.g., y), that allows the device to specify positions in a plane.

The invention is related to the use of computer system 600 for bartering items between customers. According to one embodiment of the invention, the bartering of items between customers is provided by computer system 600 in response to processor 635 executing one or more sequences of one or more instructions contained in main memory 620. Such instructions may be read into main memory 620 from another computer-readable medium, such as storage device 630. Execution of the sequences of instructions contained in main memory 620 causes processor 635 to perform the process steps described herein. One or more processors in a multi-processing arrangement may also be employed to execute the sequences of instructions contained in main memory 620. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 635 for execution. Such a medium may take many forms, including but not limited to, non-volatile media, volatile media, and transmission media. Non-volatile media includes, for example, optical or magnetic disks, such as storage device 630. Volatile media includes dynamic memory, such as main memory 620. Transmission media includes coaxial cables, copper wire and fiber optics, including the wires that comprise bus 645. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 635 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector coupled to bus 645 can receive the data carried in the infrared signal and place the data on bus 645. Bus 645 carries the data to main memory 620, from which processor 635 retrieves and executes the instructions. The instructions received by main memory 620 may optionally be stored on storage device 630 either before or after execution by processor 635.

Computer system 600 also includes a communication interface 640 coupled to bus 645. Communication interface 640 provides a two-way data communication coupling to a network link 675 that is connected to a local network 655. For example, communication interface 640 may be an integrated services digital network (ISDN) card or a modem to provide a data communication connection to a corresponding type of telephone line. As another example, communication interface 640 may be a local area network (LAN) card to provide a data communication connection to a compatible LAN. Wireless links may also be implemented. In any such implementation, communication interface 640 sends and receives electrical, electromagnetic, or optical signals that carry digital data streams representing various types of information.

Network link 675 typically provides data communication through one or more networks to other data devices. For example, network link 675 may provide a connection through local network 655 to a host computer 650 or to data equipment operated by an Internet Service Provider (ISP) 665. ISP 665 in turn provides data communication services through the world wide packet data communication network now commonly referred to as the “Internet” 660. Local network 655 and Internet 660 both use electrical, electromagnetic or optical signals that carry digital data streams. The signals through the various networks and the signals on network link 675 and through communication interface 640, which carry the digital data to and from computer system 600, are exemplary forms of carrier waves transporting the information.

Computer system 600 can send messages and receive data, including program code, through the network(s), network link 675 and communication interface 640. In the Internet example, a server 670 might transmit a requested code for an application program through Internet 760, ISP 665, local network 655 and communication interface 675. In accordance with the invention, one such downloaded application provides for the renting of items to customers as described herein.

The received code may be executed by processor 635 as it is received, and/or stored in storage device 630, or other non-volatile storage for later execution. In this manner, computer system 600 may obtain application code in the form of a carrier wave.

The novel approach described herein for bartering items between customers provides several advantages over prior approaches to bartering items between customers. First, the decision of what item to request to receive may be separated from the decision of who to ask to send the item. Customers may specify what items they desire to receive and what items they are willing to sell. Customers are then sent items and are asked to send items without having to search for a customer willing to send them an item which they desire to receive or to find a customer desiring to receive an item they are willing to send.

Second, the decision of what item to request to receive may be separated from the decision of the value of the item. Customers specify what items they desire to receive and what items they are willing to send. Customers receive points for sending items, which may be used to receive other items, and the point values are determined by the provider. Customers, therefore, may avoid negotiating with other customers over the value of the items bartered.

In the foregoing specification, the invention has been described as applicable to an implementation anticipating Internet based ordering and mail or other long-distance delivery of the items, where the special advantages of the method are very attractive. However the same invention may be applied in a more conventional store setting, where customers may be allowed barter items in a passive, in-direct manner.

In the foregoing specification, the invention has been described with reference to specific embodiment thereof. However, various modifications and changed may be made thereto without departing from the broader spirit and scope of the invention. The specification and drawings are, accordingly, to be regarded in an illustrative sense rather than a restrictive sense.

1. A method for trading items between customers, the method comprising the computer-implemented steps of:
receiving one or more item selection criteria indicating zero or more items that a first customer desires to receive;
receiving one or more item selection criteria indicating zero or more items that a second customer is willing to send;
in response to a match between the one or more items indicated by the item selection criteria of the first customer and one or more items indicated by the item selection criteria of the second customer, prompting the second customer to send one or more items to the first customer;
determining the point value of the one or more items the second customer is prompted to send to the first customer;
in response to the second customer sending one or more items to the first customer, giving the second customer points and charging the first customer points based on the determination in the step determining the point value of the one or more items the second customer is prompted to send to the first customer.

2. A method as recited in claim 1, further comprising the step of maintaining a point account with the first and second customer, wherein the points are used in exchange for one or more items.

3. A method as recited in claim 1, wherein the step determining the point value of the one or more items the second customer is prompted to send to the first customer includes adjusting the point value of one or more items to alter the likelihood of the second customer sending one or more items to the first customer.

4. A method as recited in claim 1, wherein the step of prompting the second customer to send one or more items to the first customer comprises identifying to the second customer the routing protocol of sending one or more items to the second customer.

5. A method for trading items between a plurality of customers, the method comprising the computer-implemented steps of:
receiving one or more item selection criteria from a plurality of customers that indicates zero or more items that each customer desires to receive;
receiving one or more item selection criteria from a plurality of customers that indicates zero or more items that each customer is willing to send;
selecting an item delivery criteria that determines whether one or more customers of the plurality of customers will be prompted to send one or more items;
in response to a determination by the item delivery criteria, selecting one or more items indicated by the item selection criteria that indicates items that one or more customers of the plurality of customer is willing to send;
in response to selecting one or more items indicated by the item selection criteria that indicates items that one or more customers is willing to send, prompting one or more customers to send one or more items to one or more customers of the plurality of customers.

6. A method a recited in claim 5, wherein the step of in response to selecting one or more items indicated by the item selection criteria that indicates items that one or more customers is willing to send, prompting one or more customers to send one or more items to another customer of the plurality of customers includes prompting a first customer to send one or more items to another customer.

7. A method as recited in claim 6, further comprising in response the first customer failing to send one or more items to another customer within a specified period of time, in response to selecting one or more items indicated by the item selection criteria that indicates items that one or more customers is willing to send, prompting a second customer to send one or more items to another customer.

8. A method as recited in claim 6, further comprising determining the point value of the one or more items selected in the step selecting one or more items indicated by the item selection criteria that indicates items that one or more customers of the plurality of customer is willing to send.

9. A method as recited in claim 8, further comprising in response to the first customer sending one or more items to the second customer, giving the first customer points and charging the second customer points, wherein the number of points is based on the determination of the step determining the point value of the one or more items selected in the step selecting one or more items indicated by the item selection criteria that indicates items that one or more customers of the plurality of customer is willing to send.

10. A method as recited in claim 6, wherein the item delivery criteria comprises determining whether there is a match between one or more items indicated by the item selection criteria of the first customer and one or more items indicated by the item selection criteria of the second customer.

11. A method as recited in claim 6, wherein the item delivery criteria is adjusted to alter the likelihood of the first customer sending one or more items to the second customer.

12. A method for trading items between a plurality of customers, the method comprising the computer-implemented steps of:
receiving one or more item selection criteria from a plurality of customers indicating zero or more items that each customer desires to receive;
receiving one or more item selection criteria from a plurality of customers indicating zero or more items that each customer is willing to send;
in response to a match between an item selection criteria of a first customer of the plurality of customers indicating an item that the first customer desires to receive and an item selection criteria of a second customer of the plurality of customers indicating an item that the second customer is willing to send, prompting the second customer to send the item to the first customer;
determining the point value of one or more items the second customer is prompted to send to the first customer;
in response to the second customer sending one or more items to the first customer, giving the second customer points and charging the first customer points based on the determination of the point value of one or more items the second customer is prompted to send the first customer.
